(19) United States
(12) Patent Application Publication
(10) Pub. No.: US 2025/0308294 A1
(43) Pub. Date: Oct. 2, 2025

(54) MANAGEMENT DEVICE AND VEHICLE INFORMATION MANAGEMENT SYSTEM

(71) Applicant: TOYOTA JIDOSHA KABUSHIKI KAISHA, Toyota-shi (JP)

(72) Inventors: Yasuhide KURIMOTO, Kasugai-shi (JP); Hiroshi Yamasaki, Nagoya-shi (JP); Masahiro Kagami, Nagoya-shi (JP); Kenji Zaitsu, Nagoya-shi (JP)

(73) Assignee: TOYOTA JIDOSHA KABUSHIKI KAISHA, Toyota-shi (JP)

(21) Appl. No.: 18/979,680

(22) Filed: Dec. 13, 2024

(30) Foreign Application Priority Data
Mar. 26, 2024 (JP) 2024-048938

(51) Int. Cl. G07C 5/00; G07C 5/08

(52) U.S. Cl. CPC G07C 5/008; G07C 5/085

(57) ABSTRACT

A management device includes a storage device. The management device acquires user intention information indicating whether or not there is agreement of a vehicle user to disclosure of vehicle identification information on a vehicle. The management device receives vehicle information including the vehicle identification information from outside through communication. When the agreement of the vehicle user exists, the management device keeps the vehicle information including the vehicle identification information in the storage device. On the other hand, when the agreement of the vehicle user does not exist, the management device acquires first identification information that is different from the vehicle identification information, keeps first corrected vehicle information including the first identification information in place of the vehicle identification information in the storage device, and deletes the vehicle identification information.

### CROSS-REFERENCE TO RELATED APPLICATION

This application claims priority to Japanese Patent Application No. 2024-048938 filed on Mar. 26, 2024, incorporated herein by reference in its entirety.

### BACKGROUND

### 1. Technical Field

The present disclosure relates to a technology of collecting and managing information related to a vehicle.

### 2. Description of Related Art

Japanese Unexamined Patent Application Publication No. 2007-264730 discloses an information mediation system. The information mediation system includes an information provider terminal, a user terminal, and a mediation server. The information provider terminal transmits information to the mediation server. The mediation server collects and accumulates the information from the information provider terminal. When providing the accumulated information to the user terminal, the mediation server replaces attribute information on the information provider that is not permitted to be disclosed with dummy information.

Japanese Unexamined Patent Application Publication No. 2015-101195 discloses a vehicle information communication system. A vehicle converts a vehicle identifier unique to the vehicle into another identifier by using conversion information. Then, the vehicle associates vehicle state information with the other identifier and transmits the vehicle state information to a vehicle state information server. When use of the vehicle state information is requested by a specific business operator, the vehicle state information server transmits, to the vehicle, information for inquiring whether or not a vehicle user permits use of the vehicle state information. When the vehicle user permits use of the vehicle state information, the conversion information is transmitted from the vehicle to the vehicle state information server. The vehicle state information server converts in reverse from the other identifier to the original vehicle identifier by using the conversion information received from the vehicle. Then, the vehicle state information server associates the vehicle state information with the original vehicle identifier and provides the vehicle state information to the specific business operator.

### SUMMARY

According to the technology described in JP 2007-264730 A, even if attribute information on an information provider is not permitted to be disclosed, the attribute information on the information provider is accumulated in the mediation server. There can be some information providers that feel a dislike or distrust of such a fact. Moreover, there is a possibility that attribute information on an information provider is leaked outside from the mediation server. Such a fact is unfavorable from a viewpoint of protecting personal information.

A first aspect relates to a management device.
The management device includes an information processing device that includes a storage device.
The information processing device acquires user intention information indicating whether or not there is agreement of a vehicle user to disclosure of vehicle identification information on a vehicle.
The information processing device receives vehicle information including the vehicle identification information from outside through communication.
When the agreement of the vehicle user exists, the information processing device keeps the vehicle information including the vehicle identification information in the storage device.
In contrast, when the agreement of the vehicle user does not exist, the information processing device acquires first identification information that is different from the vehicle identification information, keeps first corrected vehicle information including the first identification information in place of the vehicle identification information in the storage device, and deletes the vehicle identification information.

A second aspect relates to a vehicle information management system.
The vehicle information management system includes: a vehicle that stores vehicle information including vehicle identification information; a management device that includes a storage device; and a first device that provides the vehicle information to the management device through communication.
The management device acquires user intention information indicating whether or not there is agreement of a vehicle user to disclosure of the vehicle identification information.
The management device receives the vehicle information including the vehicle identification information from the first device through communication.
When the agreement of the vehicle user exists, the management device keeps the vehicle information including the vehicle identification information in the storage device.
In contrast, when the agreement of the vehicle user does not exist, the management device acquires first identification information that is different from the vehicle identification information, keeps first corrected vehicle information including the first identification information in place of the vehicle identification information in the storage device, and deletes the vehicle identification information.

According to the present disclosure, when there is no agreement of a vehicle user, the management device keeps first corrected vehicle information including first identification information in place of vehicle identification information. The vehicle identification information is deleted and is not kept in the management device. Accordingly, it does not happen that the vehicle identification information is leaked outside from the management device. Thus, personal information on the vehicle user is effectively protected. Moreover, dislike and distrust felt by the vehicle user are also reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram for describing an outline of a vehicle information management system;

FIG. 2 is a conceptual diagram for describing collection and management of vehicle information;

FIG. 3 is a conceptual diagram for describing a first comparison example;

FIG. 4 is a conceptual diagram for describing a second comparison example;

FIG. 5 is a conceptual diagram for describing a third comparison example; and

FIG. 6 is a conceptual diagram for describing provision of information from the management device to another system.

### DETAILED DESCRIPTION OF EMBODIMENTS

An embodiment of the present disclosure is described with reference to the accompanying drawings.

### 1. Vehicle Information Management System

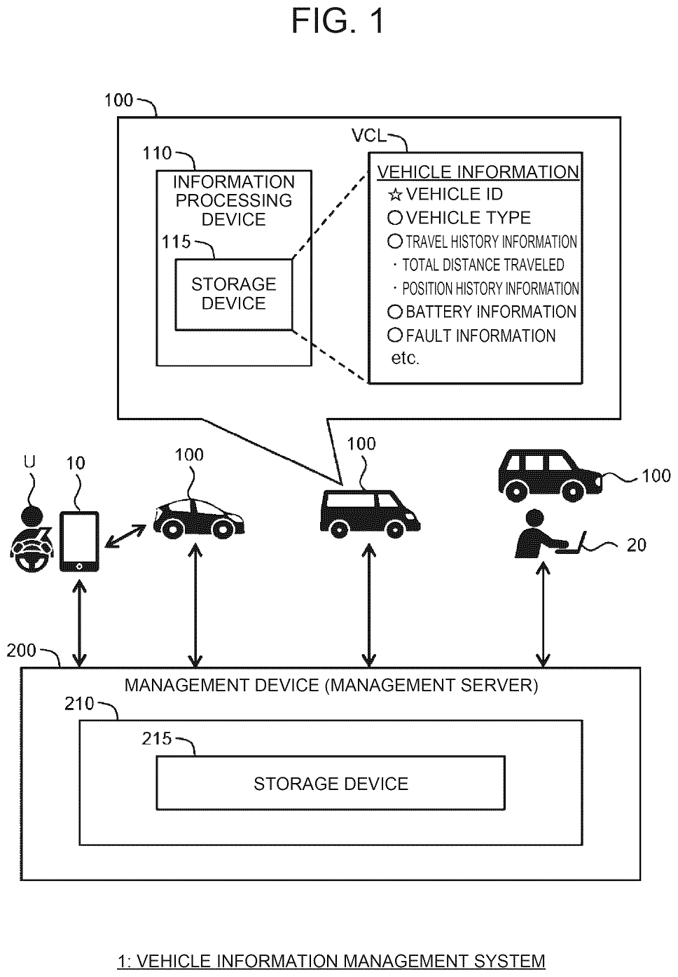

FIG. 1 is a conceptual diagram for describing an outline of a vehicle information management system 1 according to the present embodiment. The vehicle information management system 1 collects and manages information related to a vehicle 100. The vehicle information management system 1 includes one or more vehicles 100 and a management device 200. Each vehicle 100 and the management device 200 can communicate with each other via a wireless communication network.

Each vehicle 100 includes an information processing device 110. The information processing device 110 executes various information processing. Moreover, the information processing device 110 includes one or more storage devices 115 and stores various information. Examples of the storage device 115 include a volatile memory, a non-volatile memory, a hard disk drive (HDD), a solid state drive (SSD), and/or a combination of any thereof. Further, the information processing device 110 performs communication with the outside via a communication interface.

For example, the information processing device 110 includes a controller such as an electronic control unit (ECU). The information processing device 110 may include a data communication module. The information processing device 110 may include one or more processors. Examples of the processor include a general-purpose processor, an application specific processor, a central processing unit (CPU), a graphics processing unit (GPU), an application specific integrated circuit (ASIC), a field-programmable gate array (FPGA), an integrated circuit, and/or a combination of any thereof. The functionality of the information processing device 110 may be implemented through cooperation between the processor that executes a control program and the storage device 115. The control program is stored in the storage device 115. Alternatively, the control program may be recorded on a computer-readable recording medium. As a generalization, the information processing device 110 can also be referred to as processing circuitry.

Vehicle information VCL related to a vehicle 100 is stored in the storage device 115 of the information processing device 110. In other words, the information processing device 110 stores vehicle information VCL related to a vehicle 100. The vehicle information VCL includes vehicle identification information (hereinafter, referred to as “vehicle ID”) unique to the vehicle 100. A vehicle ID is also referred to as a vehicle identification number (VIN). In addition to the vehicle ID, the vehicle information VCL may include information as mentioned below. In other words, in the vehicle information VCL, the vehicle ID and information as mentioned below may be associated with each other.

For example, the vehicle information VCL may include vehicle type information on the vehicle 100.

As another example, the vehicle information VCL may include travel history information indicating travel history of the vehicle 100. For example, the travel history information includes a total distance traveled by the vehicle 100. As another example, the travel history information may include position history information on the vehicle 100. A position of the vehicle 100 may be represented by a combination of a latitude and a longitude.

When the vehicle 100 is a battery electric vehicle (BEV) or a hybrid electric 20 vehicle (HEV, PHEV), the vehicle information VCL may include battery information related to an on-board battery. For example, the battery information includes battery usage history information. The battery usage history information includes at least one of temperature history, state-of-charge (SOC) history, current history, voltage history, charge history, and the like. Each history may be represented by a frequency distribution. The battery information may include a state of health (SOH). The SOH may be calculated based on the 25 battery usage history information.

As still another example, the vehicle information VCL may include fault information indicating details of a fault occurring in the vehicle 100. For example, the fault information can be acquired by a self-diagnosis function of the vehicle 100.

The management device 200 performs communication with one or more vehicles 100, and collects and manages information related to the one or more vehicles 100. The management device 200 can also be referred to as a management server. The management device 200 may be configured by using a plurality of servers that performs distributed processing.

The management device 200 includes an information processing device 210. The information processing device 210 executes various information processing. Moreover, the information processing device 210 includes one or more storage devices 215 and stores (keeps) various information. Examples of the storage device 215 include a volatile memory, a non-volatile memory, an HDD, an SSD, and/or a combination of any thereof. Further, the information processing device 210 performs communication with the outside via a communication interface.

The information processing device 210 may include one or more processors. Examples of the processor include a general-purpose processor, an application specific processor, a CPU, an ASIC, an FPGA, an integrated circuit, and/or a combination of any thereof. The functionality of the information processing device 210 may be implemented through cooperation between the processor that executes a management program and the storage device 215. The management program is stored in the storage device 215. Alternatively, the management program may be recorded on a computer-readable recording medium. As a generalization, the information processing device 210 can also be referred to as processing circuitry.

The vehicle information management system 1 may further include a user terminal 10. The user terminal 10 is a terminal that is used by a vehicle user U. The vehicle user U is a person who uses a vehicle 100. For example, the vehicle user U is an owner of the vehicle 100. For the user terminal 10, an on-board terminal, a PC, a tablet, a smartphone, and the like are recited as examples. The user terminal 10 can communicate with the vehicle 100 and the management device 200 via a communication network.

The vehicle information management system 1 may further include a dealer terminal 20 that is used in a vehicle dealer. In the vehicle dealer, vehicle information VCL can be read from the storage device 115 of a vehicle 100 by using a predetermined tool. The vehicle information VCL read from the vehicle 100 is input into the dealer terminal 20. In other words, the dealer terminal 20 can acquire vehicle information VCL. The dealer terminal 20 can communicate with the management device 200 and the user terminal 10 via a wireless or wired communication network.

The management device 200 can collect vehicle information VCL from at least one of the information processing device 110 of a vehicle 100 and the dealer terminal 20. In other words, the management device 200 may collect vehicle information VCL directly from a vehicle 100 or via the dealer terminal 20. For convenience, the information processing device 110 of each vehicle 100 and the dealer terminal 20 will be collectively referred to as “first device”. The first device can acquire vehicle information VCL and can communicate with the user terminal 10 and the management device 200. The management device 200 can collect the vehicle information VCL from the first device by performing communication with the first device.

Hereinafter, the collection and management of vehicle information VCL in the vehicle information management system 1 according to the present embodiment are described in detail.

### 2. Collection and Management of Vehicle Information

As described above, a vehicle ID is unique to a vehicle 100. Accordingly, a vehicle 100 can be identified from a vehicle ID. If information exists that indicates a correspondence between a vehicle ID and a vehicle user U, a vehicle user U can also be identified from a vehicle ID. In other words, it can be said that a vehicle ID has an aspect serving as personal information. From a viewpoint of protecting personal information, handling of vehicle information VCL that includes a vehicle ID requires great caution.

According to the present embodiment, adequate consideration is given to whether or not there is agreement of a vehicle user U to disclosure of a vehicle ID to a third party. Methods of collecting and managing vehicle information VCL are changed depending on whether or not there is agreement of a vehicle user U to disclosure of a vehicle ID.

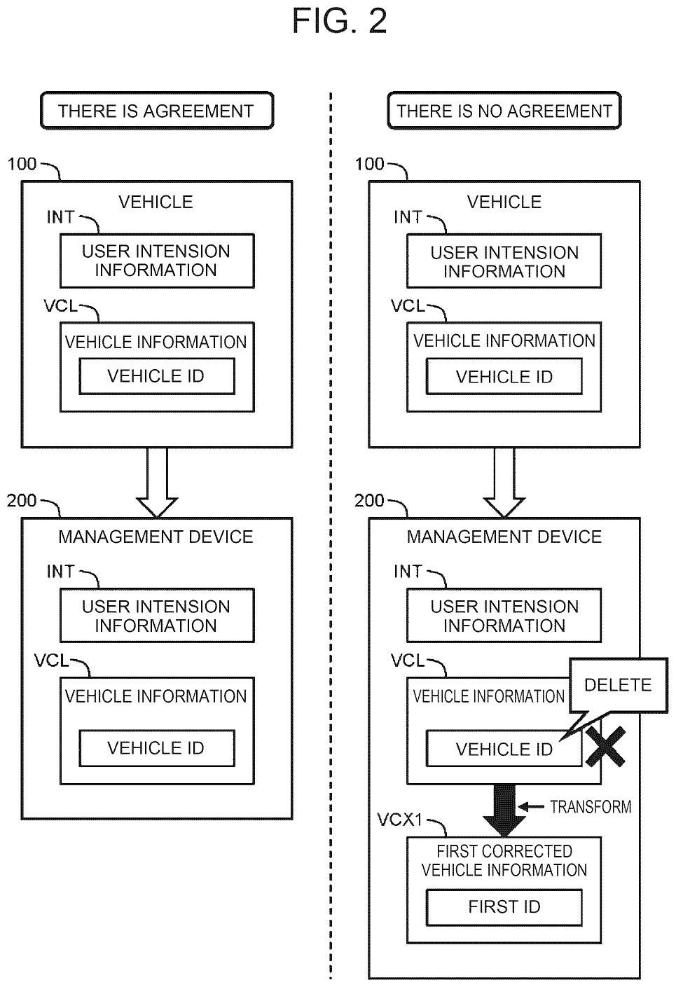

FIG. 2 is a conceptual diagram for describing the collection and management of vehicle information VCL in the present embodiment. Note that as described above, vehicle information VCL can be collected directly from a vehicle 100 or via the dealer terminal 20. When a generalization is made, it will be assumed that “vehicle 100” in the description below is replaced with “first device”.

User intention information INT is information indicating whether or not there is agreement of a vehicle user U to disclosure of a vehicle ID to a third party. When the vehicle user U agrees to disclosure of the vehicle ID, the user intention information INT indicates “agreement”. In contrast, when the vehicle user U does not agree to disclosure of the vehicle ID, the user intention information INT indicates “non-agreement”. A vehicle 100 acquires user intention information INT indicating an intension of a vehicle user U of the vehicle 100. In particular, before a stage in which vehicle information VCL is provided to the management device 200, the vehicle 100 acquires the user intention information INT indicating the intention of the vehicle user U of the vehicle 100 beforehand. For example, the vehicle user U inputs the user intention information INT by using a user terminal 10. The user terminal 10 performs communication with the vehicle 100 and transmits the user intention information INT to the vehicle 100. The vehicle 100 receives the user intention information INT and stores the user intention information INT in the storage device 115.

The vehicle 100 performs communication with the management device 200 and provides the user intention information INT and the vehicle information VCL to the management device 200. The management device 200 receives the user intention information INT and the vehicle information VCL from the vehicle 100.

When the user intention information INT indicates “agreement”, that is, when there is agreement of the vehicle user U, the management device 200 keeps the vehicle information VCL including the vehicle ID as it is in the storage device 215. In other words, the management device 200 keeps the vehicle ID and the vehicle information VCL in association with each other.

In contrast, when the user intention information INT indicates “non-agreement”, that is, when there is no agreement of the vehicle user U, the management device 200 acquires first identification information (hereinafter, referred to as “first ID”) that is different from the vehicle ID. For example, the management device 200 transforms the vehicle ID into the first ID by using a transformation algorithm. The management device 200 may transform the vehicle ID into the first ID by using a fixed transformation algorithm. In such a case, each first ID is not the original vehicle ID itself and differs from vehicle 100 to vehicle 100. Moreover, the management device 200 may irreversibly transform the vehicle ID into the first ID by using an irreversible transformation algorithm. As another example, the first ID may be a random number generated at random.

The management device 200 acquires first corrected vehicle information VCX1 by replacing the vehicle ID in the vehicle information VCL with the first ID. In other words, the first corrected vehicle information VCX1 includes the first ID in place of the vehicle ID. It can also be said that in the first corrected vehicle information VCX1, the first ID and other vehicle information VCL are associated. The management device 200 keeps not the vehicle information VCL but the first corrected vehicle information VCX1 in the storage device 215.

Further, when there is no agreement of the vehicle user U, the management device 200 deletes the vehicle ID received from the vehicle 100. In other words, the management device 200 does not keep the vehicle ID.

As described above, according to the present embodiment, consideration is given to whether or not there is agreement of a vehicle user U to disclosure of a vehicle ID. Methods of collecting and managing vehicle information VCL are changed depending on whether or not there is agreement of a vehicle user U to disclosure of a vehicle ID.

When there is no agreement of a vehicle user U, the management device 200 keeps first corrected vehicle information VCX1 that includes a first ID in place of a vehicle ID. The vehicle ID is deleted and is not kept in the management device 200. Accordingly, it does not happen that the vehicle ID is leaked outside from the management device 200. Thus, personal information on the vehicle user U is effectively protected. Moreover, dislike and distrust felt by the vehicle user U for the vehicle information management system 1 are also reduced.

In contrast, when there is agreement of a vehicle user U, the management device 200 does not need to transform a vehicle ID into a first ID. Since a transformation process is not uniformly performed, a processing load on the management device 200 is reduced.

Moreover, when there is agreement of a vehicle user U, vehicle information VCL including a vehicle ID is kept in the management device 200. Accordingly, the management device 200 can use the vehicle ID. For example, vehicle IDs are advantageous for market fault analysis. The management device 200 can collect fault information from many vehicles 100. However, when vehicle IDs cannot be used, only statistical information related to faults can be acquired. A long time may be required to specifically identify a cause of a fault from the statistical information. In addition, when vehicle IDs cannot be used, fault information collected from the same vehicle 100 may be counted multiple times, and as a result, accuracy of the statistical information may decrease. The decrease in accuracy of the statistical information leads also to a decrease in accuracy of fault analysis. In other words, the unavailability of vehicle IDs results in decreases in efficiency and accuracy of fault analysis. In contrast, when vehicle IDs can be used, since a vehicle 100 in which a fault occurs can be identified, it is possible to determine a cause of the fault with efficiency and accuracy.

When there is no agreement of a vehicle user U, first corrected vehicle information VCX1 including a first ID in place of a vehicle ID is kept in the management device 200. The first ID may be generated from the vehicle ID through transformation using the fixed transformation algorithm. In such a case, each first ID is not the original vehicle ID itself and differs from vehicle 100 to vehicle 100. Accordingly, fault information collected from the same vehicle 100 is restrained from being counted multiple times, and accuracy of statistical information related to a fault is restrained from decreasing.

Moreover, according to the present embodiment, the process of transforming a vehicle ID into another ID is not performed by a vehicle 100. Accordingly, a processing load on the vehicle 100 is reduced.

To more clearly describe various advantageous effects brought about by the present embodiment, comparison with various comparison examples will be made.

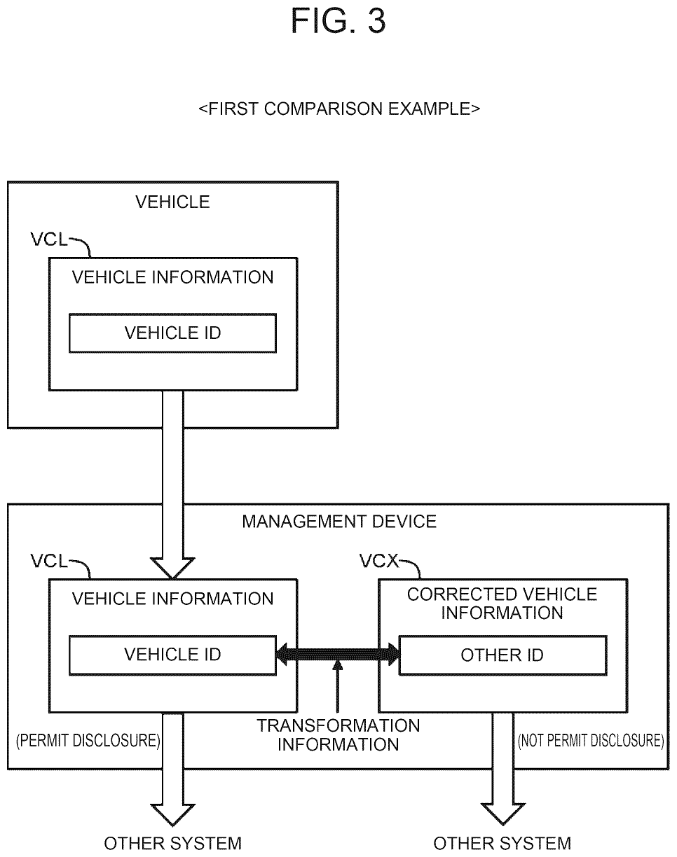

FIG. 3 is a conceptual diagram for describing a first comparison example. According to the first comparison example, vehicle information VCL including a vehicle ID is transmitted from a vehicle to a management device. Then, the vehicle information VCL including the vehicle ID is kept in the management device, regardless of whether or not there is agreement of a vehicle user U. When the vehicle user U does not permit to disclose the vehicle ID to a third party, the management device transforms the vehicle ID into another ID by using transformation information and provides corrected vehicle information VCX including the other ID to another system.

However, there are some vehicle users U who feel a dislike or distrust of the fact that vehicles ID are kept in the management device. Moreover, there is a possibility that a vehicle ID kept in the management device is leaked outside. Such a fact is unfavorable from a viewpoint of protecting personal information.

In contrast, according to the present embodiment, when there is no agreement of a vehicle user U, the management device 200 keeps first corrected vehicle information VCX1 including a first ID in place of a vehicle ID. The vehicle ID is deleted and is not kept in the management device 200. Accordingly, it does not happen that the vehicle ID is leaked outside from the management device 200. Thus, personal information on the vehicle user U is effectively protected. Moreover, dislike and distrust felt by the vehicle user U for the vehicle information management system 1 are also reduced.

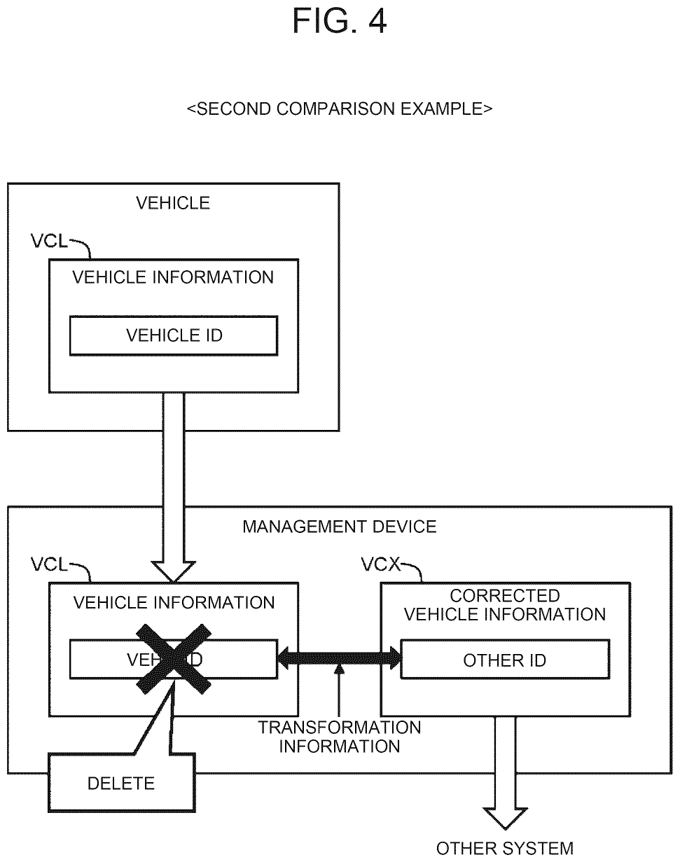

FIG. 4 is a conceptual diagram for describing a second comparison example. According to the second comparison example, vehicle information VCL including a vehicle ID is transmitted from a vehicle to a management device. The management device transforms the vehicle ID into another ID by using transformation information, regardless of whether or not there is agreement of a vehicle user U, and thereafter deletes the vehicle ID. The management device provides corrected vehicle information VCX including the other ID to another system.

However, since vehicle IDs are not kept in the management device, the management device cannot utilize the vehicle IDs at all. As described above, vehicle IDs are advantageous for market fault analysis, and the unavailability of any vehicle ID leads to decreases in efficiency and accuracy of fault analysis. Moreover, since a vehicle ID needs to be transformed into another ID regardless of whether or not there is agreement of a vehicle user U, a processing load on the management device increases.

In contrast, according to the present embodiment, when there is agreement of a vehicle user U, since vehicle information VCL including a vehicle ID is kept in the management device 200, the management device 200 can utilize the vehicle ID. Accordingly, it is possible to determine a cause of a fault with efficiency and accuracy. Further, when there is agreement of a vehicle user U, the management device 200 does not need to transform a vehicle ID into a first ID. Since the transformation process is not uniformly performed, a processing load on the management device 200 is reduced.

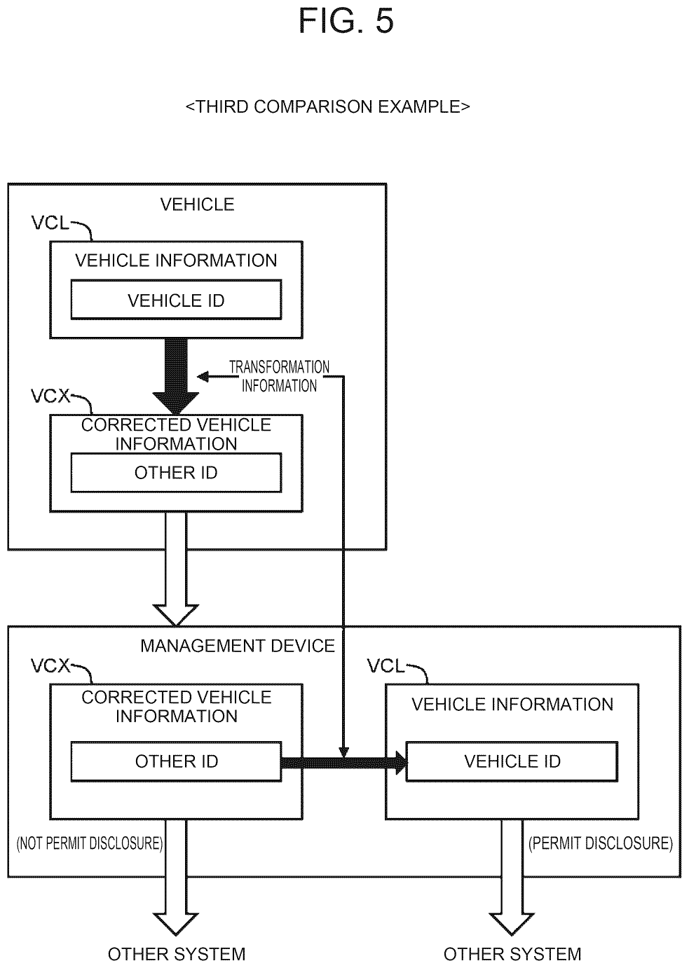

FIG. 5 is a conceptual diagram for describing a third comparison example. According to the third comparison example, a vehicle transforms a vehicle ID into another ID by using transformation information, regardless of whether or not there is agreement of a vehicle user U. Then, the vehicle transmits corrected vehicle information VCX including the other ID to a management device. The management device keeps the corrected vehicle information VCX including the other ID. Moreover, when the vehicle user U permits to disclose the vehicle ID, the management device performs communication with the vehicle and requests provision of the transformation information from the vehicle. In response to the request from the management device, the vehicle transmits the transformation information to the management device. The management device inversely transforms the other ID into the original vehicle ID by using the transformation information received from the vehicle. Then, the management device provides the vehicle information VCL including the vehicle ID to another system.

However, the fact that a vehicle transforms a vehicle ID into another ID regardless of whether or not there is agreement of a vehicle user U results in an increased processing load on the vehicle. Moreover, according to the third comparison example, since vehicle IDs are not kept in the management device basically, it is difficult for the management device to utilize the vehicle IDs. The unavailability of vehicle IDs leads to decreases in efficiency and accuracy of fault analysis. In order for the management device to restore a vehicle ID, transformation information needs to be provided from a vehicle as described above, and to do so, communication needs to be performed a plurality of times between the vehicle and the management device. Such a fact results in a stressed communication band and an increased communication cost.

In contrast, according to the present embodiment, the process of transforming a vehicle ID into another ID is not performed by a vehicle 100. Accordingly, a processing load on the vehicle 100 is reduced. Moreover, when there is agreement of a vehicle user U, since vehicle information VCL including a vehicle ID is kept in the management device 200, the management device 200 can utilize the vehicle ID. Accordingly, it is possible to determine a cause of a fault with efficiency and accuracy. Further, when there is agreement of a vehicle user U, since a vehicle ID is kept as it is, a process of inversely transforming a first ID into the vehicle ID does not occur afterward. The fact that the inverse transformation is not needed contributes to a reduction in processing load in the system as a whole. Moreover, since information required for the inverse transformation does not need to be exchanged between a vehicle 100 and the management device 200, consumption of a communication band can be reduced, and a communication cost can also be reduced.

### 3. Abstraction of Travel History Information

A case is considered where vehicle information VCL includes travel history information, which indicates travel history of a vehicle 100. The possibility of a vehicle 100 being identified from travel history of the vehicle 100 cannot be ruled out.

For example, the travel history information includes a total distance traveled by the vehicle 100. If the total distance traveled in digits is known down to the ones place, there is a possibility that the vehicle 100 is identified from the total distance traveled. Accordingly, when providing vehicle information VCL to the management device 200, the vehicle 100 (information processing device 110) may round the total distance traveled included in the vehicle information VCL. For example, rounding the total distance traveled may be rounding the total distance traveled down to a predetermined place (examples: the nearest 100, the nearest 1,000). As another example, rounding the total distance traveled may be rounding the total distance traveled up to a predetermined place. As still another example, rounding the total distance traveled may be rounding off the total distance traveled to a predetermined place. As a result, a value obtained by rounding the total distance traveled is a round value, such as 1,000 km or 2,000 km. As even another example, rounding the total distance traveled may be expressing the total distance traveled in units of a predetermined distance. The predetermined distance constituting a unit is arbitrary, and examples thereof are 500 km, 2,000 km, 5,000 km, and the like. As an example, a case is considered where the total distance traveled is expressed in units of 2,000 km. When the total distance traveled is less than 2,000 km, the total distance traveled is represented by 0 km; when the total distance traveled is equal to or more than 2,000 km and less than 4,000km, the total distance traveled is represented by 2,000 km; and when the total distance traveled is equal to or more than 4,000 km and less than 6,000 km, the total distance traveled is represented by 4,000 km. The same applies when the predetermined distance is another value. The vehicle information VCL obtained after rounding as described above includes not the total distance traveled itself but the value obtained by rounding the total distance traveled. Such vehicle information VCL is provided from the vehicle 100 to the management device 200. Thus, the protection of personal information is further strengthened.

As another example, the travel history information includes position history information on the vehicle 100. A position of the vehicle 100 is represented by a combination of a latitude and a longitude. There is a possibility that the vehicle 100 is identified from latitude and longitude history. Accordingly, when providing vehicle information VCL to the management device 200, the vehicle 100 (information processing device 110) may abstract the position history information included in the vehicle information VCL. Abstracting the position history information means, for example, replacing the latitude and longitude history with the name of a predetermined area (examples: a prefecture, a municipality, a state, a city, and the like). The vehicle information VCL thus obtained includes not the position history information itself but abstract position history information obtained by abstracting the position history information. Such vehicle information VCL is provided from the vehicle 100 to the management device 200. Thus, the protection of personal information is further strengthened.

As still another example, the management device 200, instead of the vehicle 100, may round the total distance traveled or abstract the position history information. Thus, similar advantageous effects can also be brought about.

### 4. Provision of Vehicle Information to Other System

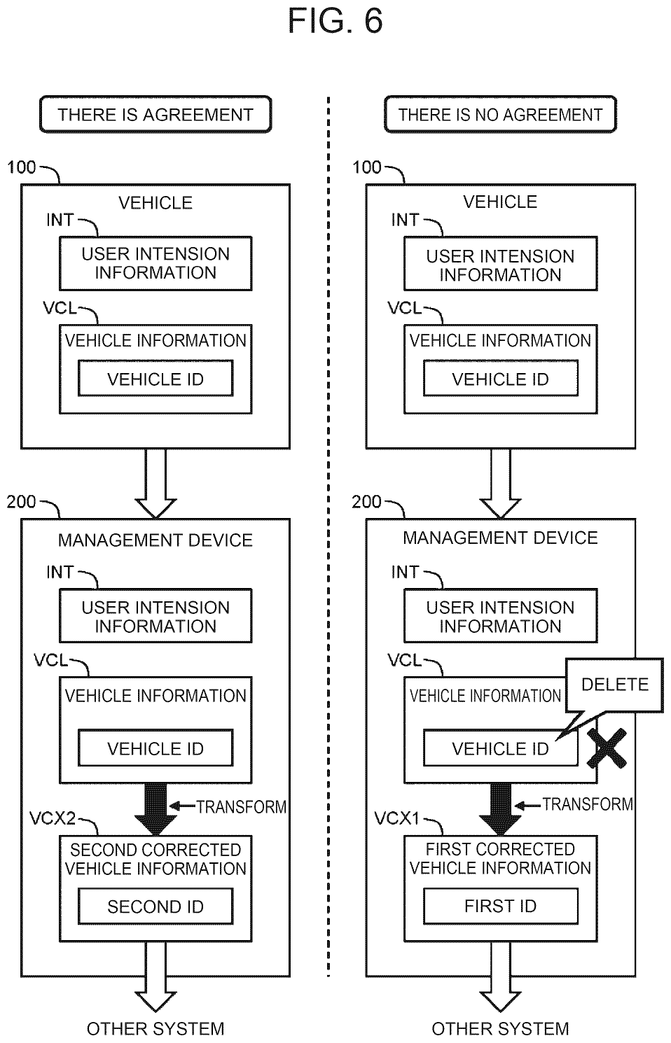

FIG. 6 is a conceptual diagram for describing provision of information from the management device 200 to another system. When first corrected vehicle information VCX1 is kept in the management device 200, the management device 200 provides the first corrected vehicle information VCX1 to another system.

In contrast, when vehicle information VCL is kept in the management device 200, the management device 200 acquires a second identification information (hereinafter, referred to as “second ID”) that is different from a vehicle ID included in the vehicle information VCL. For example, the management device 200 transforms the vehicle ID into the second ID by using a fixed transformation algorithm. In such a case, each second ID is not the original vehicle ID itself and differs from vehicle 100 to vehicle 100. Moreover, the management device 200 may irreversibly transforms the vehicle ID into the second ID by using an irreversible transformation algorithm. As another example, the second ID may be a random number generated at random.

The management device 200 acquires second corrected vehicle information VCX2 by replacing the vehicle ID in the vehicle information VCL with the second ID. In other words, the second corrected vehicle information VCX2 includes the second ID in place of the vehicle ID. It can also be said that in the second corrected vehicle information VCX2, the second ID and other vehicle information VCL are associated. The management device 200 provides not the vehicle information VCL itself but the second corrected vehicle information VCX2 to another system even when there is agreement of a vehicle user U.

As a result, regardless of whether or not there is agreement of a vehicle user U, the information provided from the management device 200 to the other system does not include a vehicle ID. Thus, the protection of personal information is further strengthened.

What is claimed is:

1. A management device comprising an information processing device that includes a storage device, wherein
the information processing device is configured to
acquire user intention information indicating whether or not there is agreement of a vehicle user to disclosure of vehicle identification information on a vehicle,
receive vehicle information including the vehicle identification information from outside through communication,
when the agreement of the vehicle user exists, keep the vehicle information including the vehicle identification information in the storage device, and
when the agreement of the vehicle user does not exist, acquire first identification information that is different from the vehicle identification information, keep first corrected vehicle information including the first identification information in place of the vehicle identification information in the storage device, and delete the vehicle identification information.

2. The management device according to claim 1, wherein when the agreement of the vehicle user does not exist, the information processing device is configured to transform the vehicle identification information into the first identification information by using a fixed transformation algorithm.

3. The management device according to claim 1, wherein the information processing device is further configured to
transform the vehicle identification information included in the vehicle information into second identification information, and
provide second corrected vehicle information including the second identification information in place of the vehicle identification information to another system even when the agreement of the vehicle user exists.

4. A vehicle information management system comprising:
a vehicle that stores vehicle information including vehicle identification information;
a management device that includes a storage device; and
a first device that provides the vehicle information to the management device through communication,
wherein the management device is configured to
acquire user intention information indicating whether or not there is agreement of a vehicle user to disclosure of the vehicle identification information,
receive the vehicle information including the vehicle identification information from the first device through communication,
when the agreement of the vehicle user exists, keep the vehicle information including the vehicle identification information in the storage device, and
when the agreement of the vehicle user does not exist, acquire first identification information that is different from the vehicle identification information, keep first corrected vehicle information including the first identification information in place of the vehicle identification information in the storage device, and delete the vehicle identification information.

5. The vehicle information management system according to claim 4, wherein the management device is further configured to
transform the vehicle identification information included in the vehicle information into second identification information, and
provide second corrected vehicle information including the second identification information in place of the vehicle identification information to another system even when the agreement of the vehicle user exists.
